(19) United States
(12) Patent Application Publication
(10) Pub. No.: US 2020/0056952 A1
(43) Pub. Date: Feb. 20, 2020

(54) DEVICE FOR MEASURING PRESSURE

(71) Applicant: ZF Friedrichshafen AG, Friedrichshafen (DE)

(72) Inventor: Ajoy PALIT, Bremen (DE)

(73) Assignee: ZF Friedrichshafen AG, Friedrichshafen (DE)

(21) Appl. No.: 16/496,303

(22) PCT Filed: Feb. 19, 2018
(86) PCT No.: PCT/EP2018/053970

§ 371 Date: Sep. 20, 2019

(30) Foreign Application Priority Data
Mar. 24, 2017 (DE) 10 2017 205 054.3

(51) Int. Cl. G01L 9/00; G01L 7/08; G01L 9/10

(52) U.S. Cl. CPC G01L 9/007; G01L 9/10; G01L 7/08

(57) ABSTRACT

Device for measuring pressure comprising a base body, and a diaphragm that is arranged on the base body such that the base body and the diaphragm at least partially enclose a cavity, wherein the diaphragm is embodied to be deformable in accordance with the external pressure incident on it, such that the magnitude of a spatial dimension of the cavity is correspondingly changed, wherein a position element is arranged to move in accordance with the diaphragm, wherein an inductive planar coil is arranged across the cavity and opposite to the position element, such that the position element and the inductive planar coil are separated, wherein the position element serves to influence the inductance of the coil in dependence on the magnitude of the separation.

### RELATED APPLICATIONS

This application is a filing under 35 U.S.C. § 371 of International Patent Application PCT/EP2018/053970, filed Feb. 19, 2018, claiming priority to German Patent Application 10 2017 205 054.3, filed Mar. 24, 2017. All applications listed in this paragraph are hereby incorporated by reference in their entireties.

### TECHNICAL FIELD

The invention relates to a device for measuring pressure having a base body, and a diaphragm that is arranged on the base body such that the base body and the diaphragm at least partially enclose a cavity, and such that the diaphragm can be exposed to an external pressure to be monitored, wherein the diaphragm is embodied to be deformable in accordance with the external pressure incident on it, such that the magnitude of a spatial dimension of the cavity is correspondingly changed, wherein the device further has a position element, wherein the position element is arranged to move in accordance with the diaphragm, in particular being fixedly attached to the diaphragm.

### BACKGROUND

The measuring and/or monitoring of process pressures and/or the pressure in a container is commonly required in various industrial applications. There are therefore numerous measuring principles employed for this purpose.

In the patent document WO 03/106952 a MEMS (micro electrical mechanical system) pressure sensor is disclosed, which functions on the basis of a capacitive measurement principle. In particular, a change of distance between two electrodes is monitored by means of a capacitive transducer that comprises an inductive coil. A change in the distance between the electrodes due to an incident pressure leads to a change in the resonant frequency of the LC-circuit formed by the electrodes and the inductive coil. The change in the resonant frequency is monitored as it corresponds to the change in distance resulting from the incident pressure, which is to be monitored.

### SUMMARY

Against this background, the object of the invention is to introduce an improved device for monitoring pressure.

The object is achieved through a device according to the independent claims 1 and 13. Advantageous embodiments of the invention are further defined in the dependent claims and the following description.

The object is therefore achieved with a device for measuring pressure comprising a base body, a diaphragm that is arranged on the base body such that the base body and the diaphragm at least partially enclose a cavity, and such that the diaphragm can be exposed to an external pressure to be monitored, wherein the diaphragm is embodied to be deformable in accordance with the external pressure incident on it, such that the magnitude of a spatial dimension of the cavity is correspondingly changed, further comprising a position element, wherein the position element is arranged to move in accordance with the diaphragm, in particular being fixedly attached to the diaphragm, wherein an inductive planar coil is arranged on and/or in the base body, across the cavity and opposite to the position element, such that the position element and the inductive planar coil are separated in the spatial dimension, wherein the position element serves to influence the inductance of the coil in dependence on the magnitude of the separation in the spatial dimension, and wherein the device measures the external pressure on the basis of the changing inductance of the inductive planar coil.

The planar coil can be arranged in a plane that is essentially perpendicular to the direction of separation between the coil and the position element. The diaphragm can be exposed to the external pressure on a surface of the diaphragm that is facing away from the cavity. That is, the outer surface of the diaphragm can be exposed to the external pressure. The cavity can be filled with a compressible fluid. The cavity can also be exposed to an ambient pressure such that the external pressure is measured with respect to the ambient pressure. In this case, the device for measuring pressure can be referred to as a gauge pressure sensor. The external pressure can be a process pressure of a process in a container or pipe that is to be measured and/or monitored.

A device which is used to measure pressure on the basis of a changing inductance of a planar coil can advantageously resolve a movement of the position element in the micrometer range, in particular to within 10 micrometers. Furthermore, the such a device is robust in the face of adverse conditions confronted by sensor electronics, such as dust, humidity, moisture, vibration, pressure, fluctuation of day/night temperature and has a broad operating temperature range (−40° C. to +90° C.). In particular, such a noncontact type of inductive pressure sensor can be advantageous in such applications over sensors based on resistive or capacitive principles.

By modeling a planar inductive coil with a program run on a computing machine, it is possible to estimate, i.e. calculate, i.e. predict the change of such a coil's inductance in dependence on the change of distance between the coil and the position element such as, for example, a copper activator element arranged across from said planar coil. Such an estimation/calculation/prediction can be used in the evaluation of a signal from a real coil. For example, the relationship between a change in pressure and a change in the inductance can be modeled and stored in a data-processing unit and/or an evaluation unit, such that the signal from the coil can serve as an input; making possible a reverse estimation/calculation/prediction of the incident pressure.

In an embodiment of the inventive device, the device further comprises a processing unit, wherein the processing unit comprises a signal generating unit that serves to generate an electrical signal, and in that the signal generating unit is electrically connected to the coil, such that the electrical input signal can be transmitted to the coil.

The pressure sensing device can comprise, for example, a signal generating unit for generating a sine wave signal comprising an amplifier. The signal generating unit can also be embodied to generate a square wave input signal for the coil.

In an embodiment of the inventive device the processing unit comprises an evaluation unit, wherein the evaluation unit has a signal receiving interface, which is electrically connected to the coil and the signal generating unit, wherein the evaluation unit serves to determine the external pressure on the basis of an electrical output signal output from the coil to the signal receiving interface.

As with the input signal, the output signal can be for example a sine wave or a square wave, which can generally be understood as a summation of sine waves. The signal receiving interface should therefore be embodied to receive and an analog signal having one of these forms.

The processing unit can be located locally, i.e. within the housing of the device, or remotely. In the case where the processing unit is located remotely, the housing can comprise electrical contacts, which are connected to input and output contacts leading to the planar coil. A remotely located processing unit enables the use of low cost components, since certain durability requirements can be eliminated or lowered. For example, components suitable for use in a restricted temperature range may be used in a remotely located processing unit.

In an embodiment of the inventive device the processing unit comprises a sampling module, in particular an analog to digital converter, which serves to sample the output signal from the coil. An analog output signal from the coil can therefore be converted to digital form, greatly reducing the difficulty of mathematical processing the signal.

In an embodiment of the inventive device the position element comprises copper. When the copper activator (i.e. position) element is brought very close to the planar coil the coupling factor increases from 0 to some moderate value (e.g., 0.5 to 0.6) and thereby, the inductance of planar coil is reduced approximately by 40% to 50% of its nominal value. When the position/activator element moves away further from the concerned planar coil the coupling factor is reduced to zero value and therefore, inductance value of the planar coil goes back to its nominal value. The change of planar coil's inductance value is suitably converted to a corresponding voltage signal and the location of the position element is estimated. The aforementioned physical phenomenon can also be explained alternatively as follows. When an alternating current flows into the planar coil it produces a varying magnetic flux in the surrounding air core. The varying magnetic field impinging on a “shorted secondary winding” i.e. the copper activator/position element induces further a varying voltage and current in accordance with Faraday's electromagnetism law. The induced current in the copper activator/position element, termed as eddy current, further opposes the varying magnetic flux generation in accordance with Lenz's law and thus also opposing the current flow into the planar coil by giving rise to the lower coil inductance value. The higher the frequency of primary current, larger is the eddy current effect in the copper plate. This, in turn, reduces the coil inductance of the inductive sensor.

In an embodiment of the inventive device the position element comprises an electrically isolating and ferromagnetic material, in particular Nickel-Zinc-Ferrite and/or Manganese-Zinc-Ferrite. The position element can comprise a highly permeable and electrically poorly conducting material. Examples of such materials are MP1040-200, MP1040-100 from Laird-Technologies or WE354006 of the WE-FSFS-354—Material group, which can be acquired from the company Würth-Elektronik in the year 2017. These materials are suitable for shielding from 13.56 MHz-RFID transponders. The material WE354006 can have a block form, with a respective width and length of 60 mm, and a thickness of 0.3 mm, which can be sliced in to required size. The complex permeability at a frequency range around 13.56 MHz is μ′=150, μ″=90, where the relative permeability is defined as μr=μ′−jμ″ or relatedly μr=B/B0=√(μ′²+μ″²)=ca. 175. Here, B is the magnetic flux density in the ferrite material, and B0 is the magnetic flux density in vacuum or air.

In contrast to a conventional arrangement in which the position element comprises an electrically conductive metal and which reduces the inductance of the coil by eddy current formation, the ferromagnetic and electrically insulating material can increase the inductance of the coil. As a result, a useful signal can be increased and a signal-to-noise ratio (SNR) can be increased. A multi-stage amplification of the useful signal can thereby be dispensed with. By increasing the inductance, the basic inductance of the coil can be relatively small without the influence of the positioning element. The coil can thus have reduced dimensions. The inductance of the coil is usually determined by exciting the coil by means of an electrical voltage at a frequency in the Megahertz MHz range. This frequency can be significantly lower than in arrangements with a metallic position element. The frequency may, for example, be approximately 12 MHz and thereby be several orders of magnitude less than in arrangements with a conducting position element. A circuit for providing this frequency and the evaluation device can be implemented more simply or with less expensive components because of the reduced frequency. Switching elements for connecting the coil to the frequency can also be more cost-effective. Electromagnetic compatibility of the device may also be improved.

The inductance increase through the position element can be more pronounced than the attenuation by a metallic position element so that the tolerances of the elements of the device for inductive position determination can be selected to be larger. As a result, more cost-effective components can be used and calibration of the device within the scope of production can be dispensed with.

Additionally, the use of a non-conducting, ferromagnetic position element can be used in pressure sensing applications where a metallic positioning element such as copper where the positioning element is exposed to oxidizing or etching agents.

In an embodiment of the inventive device the diaphragm is formed from a ceramic material. Ceramic diaphragms are exceptionally temperature resistant and can be used in applications where a process to be monitored is at a high temperature, for example above 100 degrees Celsius.

In an alternative embodiment of the inventive device the diaphragm is formed from a metal, in particular a thin sheet of metal, and/or is coated with a paint and/or Teflon i.e. PTFE.

The diaphragm can also be formed from a synthetic polymer based material.

In an embodiment of the inventive device the position element is essentially flat and has a rhombus or hexagonal shape. It is also possible for the position element to have a rectangular, circular or other geometrical shape.

Flat in the sense of the present invention describes an object that has a height which is at the most a 5th of the width and/or breadth of the object. In a conducting position element, the eddy current formation that influences the coil inductance takes place at or near the surface to the position element. Therefore, the use of additional material to increase the height of the position element generally has no additional advantage regarding the effect provided. Since copper in particular can be expensive, a flat form provides the best cost benefit ratio, since this is also the most effective form.

In an embodiment of the inventive device the coil is embodied as a printed conducting pathway on a substrate, in particular on a printed circuit board. The planar coil is fabricated directly on the PCB so that the coil's inductance is influenced by the eddy current damping effect due to the position element. Due to the limited space on the PCB often such coils have a smaller size and fewer turns, e.g. 8-9 turns. Again, a small coil size and fewer of turns will produce a smaller amount of inductance which may be insufficient for a reliable position sensing. Therefore, inductive position sensing method often uses the multi-layer planar coils with a copper, brass or aluminum metal plate as an activator (i.e. position) element approximately 0.15 to 0.45 mm and/or even as close as 0.7 mm over the coil, wherein the transducer generates a coil voltage/inductance that changes along with moving distance under the eddy current damping effects at higher frequencies.

Planar coils of different geometrical shapes (square, rectangular, trapezoidal, circular or even elliptical) as well as position elements of the aforementioned geometrical shapes may be used in the inventive device.

In an embodiment of the inventive device the coil comprises a first layer and a second layer, wherein the first and second layers are essentially aligned.

The orientation and position of a layer of a planar coil can be defined by an axis running through the center of an area covered by the layer of the coil in the plane of the coil and extending essentially perpendicular to the plane in which the layer of the coil is arranged. When these layers of the coil are aligned, these axes are essentially identical to each other. However, the planes in which the coils are arranged can be separated by a certain distance. This can advantageously result in a larger coil inductance. For example, the layers could be fabricated on two opposite surfaces of a printed circuit board.

The inductance of a multilayer coil in the inventive device has a greater dependence on the separation between the coil and the position element and requires less space on a printed circuit board (PCB), than a single layer coil with the same inductance dependence would require.

In an embodiment of the inventive device the coil is embodied to have only a single layer. Generally, it is difficult and expensive to automate the quality control of multi-layer planar coils. Single layer coils on the other hand can be visually inspected, for example in an automated scanning process, since the entire structure of the coil is present on one side of a substrate, such as a printed circuit board. This can reduce the costs and increase the speed of producing reliably fabricated coils.

The object is further achieved through a method for measuring pressure with a device having a base body and a diaphragm that is arranged on the base body such that the base body and the diaphragm at least partially enclose a cavity, and wherein the diaphragm is embodied to be deformable in accordance with the external pressure incident on it, such that the magnitude of a spatial dimension of the cavity is correspondingly changed, and wherein the device comprises a position element, wherein the position element is arranged to move in accordance with the diaphragm, in particular being fixedly attached to the diaphragm, wherein an inductive planar coil is arranged on and/or in the base body, across the cavity and opposite to the position element, such that the position element and the inductive planar coil are separated in the spatial dimension, wherein the position element serves to influence the inductance of the coil in dependence on the magnitude of the separation in the spatial dimension,

comprising the steps of

exposing the diaphragm to an external pressure to be monitored, and

measuring the external pressure on the basis of the changing inductance of the inductive planar coil.

The invention also relates to a differential pressure flow meter for measuring the flow of a fluid, in particular a liquid, through a pipe comprising at least one device for measuring pressure having a base body and a diaphragm that is arranged on the base body such that the base body and the diaphragm at least partially enclose a cavity, and wherein the diaphragm is embodied to be deformable in accordance with the external pressure incident on it, such that the magnitude of a spatial dimension of the cavity is correspondingly changed, and wherein the device comprises a position element, wherein the position element is arranged to move in accordance with the diaphragm, in particular being fixedly attached to the diaphragm, wherein an inductive planar coil is arranged on and/or in the base body, across the cavity and opposite to the position element, such that the position element and the inductive planar coil are separated in the spatial dimension, wherein the position element serves to influence the inductance of the coil in dependence on the magnitude of the separation in the spatial dimension and wherein the device is embodied to determine the external pressure on the basis of the changing inductance of the inductive planar coil.

The invention further relates to differential pressure level meter for measuring the level of a fluid, in particular a liquid, in a container comprising at least one device for measuring pressure having a base body and a diaphragm that is arranged on the base body such that the base body and the diaphragm at least partially enclose a cavity, and wherein the diaphragm is embodied to be deformable in accordance with the external pressure incident on it, such that the magnitude of a spatial dimension of the cavity is correspondingly changed, and wherein the device comprises a position element, wherein the position element is arranged to move in accordance with the diaphragm, in particular being fixedly attached to the diaphragm, wherein an inductive planar coil is arranged on and/or in the base body, across the cavity and opposite to the position element, such that the position element and the inductive planar coil are separated in the spatial dimension, wherein the position element serves to influence the inductance of the coil in dependence on the magnitude of the separation in the spatial dimension and wherein the device is embodied to determine the external pressure on the basis of the changing inductance of the inductive planar coil.

### BRIEF DESCRIPTION OF THE DRAWINGS

The invention will next be described with reference to the following figures. They show:

FIG. 1 a schematic diagram of an embodiment of the inventive pressure sensor;

FIG. 2a, b respectively, a perspective view of a double layered planar coil and a perspective view of a planar coil and a position element;

FIG. 3a, b a top view of a planar coil and the border of a hexagonal shaped position element, and a top view of a planar coil and the border of a rhombus shaped position element;

FIG. 4 a graphical representation of the progression of the induction of a planar coil in dependence on a spatial variation of the positioning element in a direction parallel to the plane of the coil at three distinct distances from the coil in a direction perpendicular to the plane of the coil;

FIG. 5 a graphical representation of the dependence of the induction of the planar coil with respect the distance between the position element and the planar coil in the direction perpendicular to the plane defined by the coil;

FIG. 6 a schematic representation of an embodiment of the inventive device for pressure measurement;

FIG. 7 a schematic diagram of a system comprising a pipeline for carrying a fluid such as a liquid and an embodiment of the device;

FIG. 8 a schematic diagram of a further application of an embodiment of the inventive device for measuring pressure, wherein the device is used to measure the fill level of a tank; and

FIG. 9 a schematic diagram of a further fill level measurement application of an embodiment of the inventive device.

### DETAILED DESCRIPTION

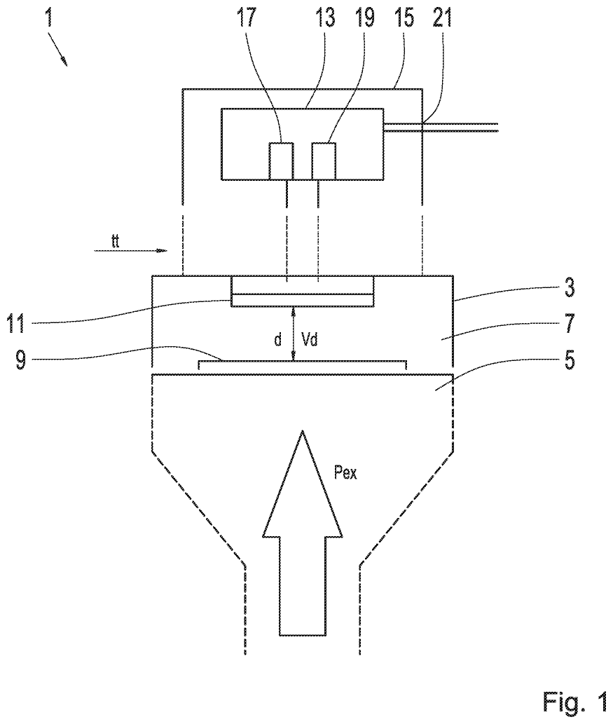

FIG. 1 shows a schematic diagram of an embodiment of the inventive pressure sensor having a base body 3 and a diaphragm 5, which is exposed to an external pressure Pex. The base body 3 and the diaphragm 5 enclose a cavity 7. Situated within the cavity 7 is a printed circuit board PCB. A planar coil 11 is arranged on the printed circuit board PCB. The planar coil 11 is electrically connected to a processing unit 13. The processing unit 13 can be arranged directly on the base body 3, and a housing enclosing the processing unit 13 can be integrally formed with the base body 3. Alternatively, the base body 3 and the processing unit 13 can be spatially separated from each other, such that the processing unit is located remotely from the external pressure Pex or process pressure to be monitored and/or measured. This variability is depicted by the dotted lines tt showing the electrical lines running between the planar coil 11 and the processing unit 13 as well as between the housing enclosing the processing unit 13 and the base body 3.

The processing unit comprises a signal generating unit 17 for transmitting an electric signal to the planar coil 11. A receiving interface 19 is provided to receive and sample the electrical signal from the planar coil 11. The relative difference between the input and output signals of the coil 11 is influenced by the inductance H of the coil 11.

The processing unit 13 further comprises a communications interface 21 for exchanging information with external devices. The interface 21 is depicted as a communications line having two conductive pathways. The communications interface 21 can however also be a single conducting pathway, or even a wireless communications interface 21.

A position element 9 is fixed to the diaphragm 5. The position element 9 is situated across the cavity 7 from the planar coil 11 and is separated from the planar coil 11 by a distance d. When a pressure is incident on the diaphragm 5, the diaphragm 5 can deform such that the distance d changes. The change in the distance d influences the inductance H of the planar coil 11 due to properties of the position element 9. The position element 9 can for example be conductive, such that eddy currents form due to the changing magnetic field produced by the coil 11 when a signal is input from the processing device. These eddy currents in turn contribute to the magnetic field and can contribute to a change in the electric potential within the metal conductive pathway of the coil 11, thereby influencing the input signal. This influence, or the result thereof, can be monitored in the processing unit 13 by examining the output signal of the coil 11 received via the receiving interface 19. On the basis of this examination, which is essentially a determination of the inductance H of the coil 11, a conclusion regarding the distance of separation of the coil 11 and the position element 9 can be reached. On the basis of this conclusion, the incident pressure can be determined.

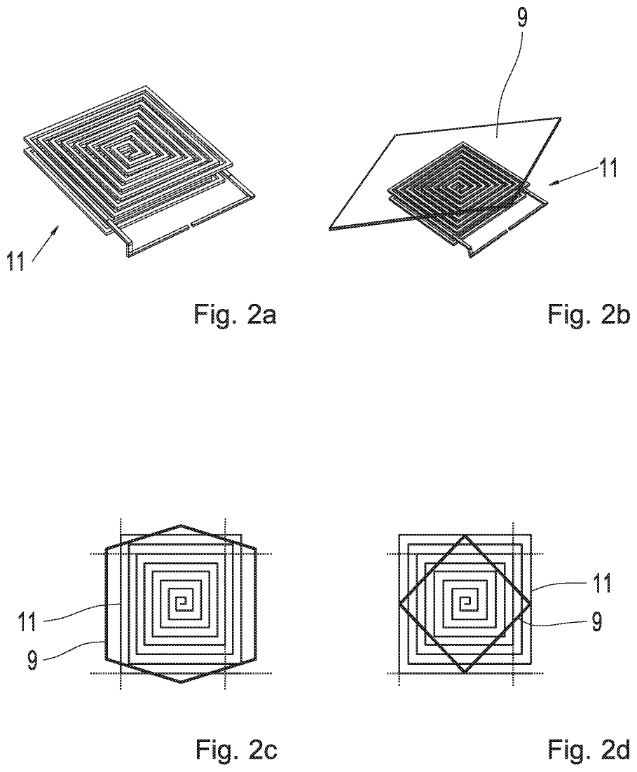

FIGS. 2a and 2b respectively show a perspective view of a double layered planar coil 11 and a perspective view of a planar coil 11 and a position element 9. The double layered planar coil 11 can be fabricated on a substrate such as a printed circuited board. For example, the upper layer can be arranged on a first side of a printed circuit board PCB, and the lower side can be arranged on a second side of the board. A connecting portion of the coil 11 is shown, which serves to connect the two layers. In FIG. 2b, a position element 9 is displayed. The position element 9 is rhombus, i.e. diamond, shaped. The position element 9 is flat, having height to width and height to breadth ratios which are each well below 1 to 5. The position element 9 is copper.

FIGS. 3a and 3b respectively show a top view of a planar coil 11 along with the border of a hexagonal shaped position element 9, and a top view of a planar coil 11 along with the border of a rhombus shaped position element 9. The position element 9 as defined through the border as shown is in each case centered i.e. aligned with respect to the coil 11. It is known, that geometries such as those shown are especially effective for influencing the inductance H of the planar coil 11.

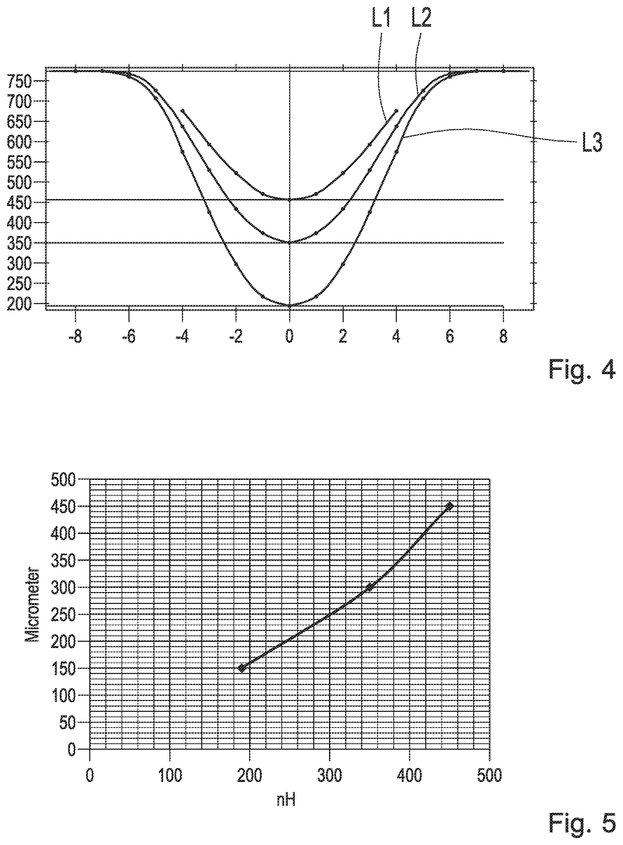

FIG. 4 shows a graphical representation of the progression of the induction of a planar coil 11 in dependence on a spatial variation of the position element 9 in a direction parallel to the plane of the coil 11 at three distinct distances from the coil 11 a direction perpendicular to the plane of the coil 11. In particular, when the position element 9 is centered over the coil 11 as depicted in FIGS. 3a and 3b, the influence of the position element 9 on the inductance H of the coil 11 is maximized. The position element 9 used here is conducting. Therefore the inductance H of the coil 11 is reduced with a decreasing separation distance between the position element 9 and the coil 11.

The first line L1 shows the progression of the inductance H when the coil 11 is positioned around 450 micrometers from the position element 9 in the direction perpendicular to the plane of the coil 11. The second line L2 i.e. progression shows the inductance H of the coil 11 when the position element 9 is separated from the coil 11 by 300 micrometers in the direction perpendicular to the plane of the coil 11. The third progression i.e. line L3 shows the inductance H of the coil 11 when the position element 9 is separated from the coil 11 by 150 micrometers in the direction perpendicular to the plane of the coil 11. Measurements of the coil 11 inductance H can be performed at this scale with an accuracy of +/−5%.

FIG. 5 shows a graphical representation of the dependence of the induction H of the planar coil 11 with respect to the distance between the position element 9 and the planar coil 11 in the direction perpendicular to the plane defined by the coil 11, in particular when the planar coil 11 and the position element 9 are aligned with respect to each other. The positions and inductances H as shown in FIG. 5 reflect the positions and resulting inductances H of the progression shown in FIG. 4. As can be seen, the dependence of the inductance H of the coil 11 is strongly dependent on the position of the position element 9, which is in this case also conductive. The use of a non-conducting ferrite position element 9 can cause an inverse of the dependence, such that with increasing distance between the planar coil 11 and the position element 9, the inductance H decreases. This is due to the magnetic conducting properties of the ferrite material.

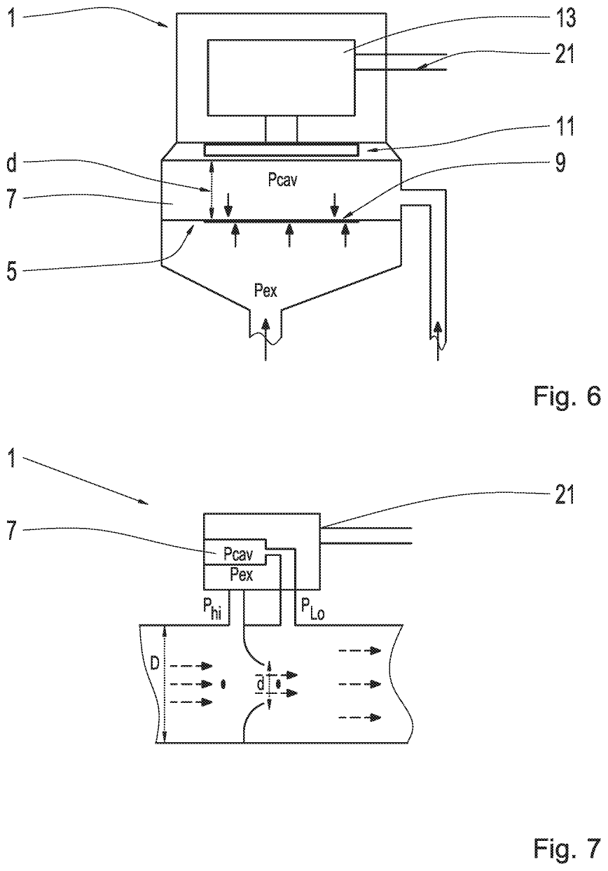

FIG. 6 shows a schematic representation of a device 1 for pressure measurement that is suitable for use in applications wherein a differential pressure measurement is required. Here, the diaphragm 5 is exposed to pressure on both on a side external Pex to the cavity 7 as well as on the side Pcav within the cavity 7. The differential pressure (ΔP=Pex−Pcav) can thereby be determined. The unequal pressure across the diaphragm 5 surface causes the diaphragm 5 together with the position element 9 (a copper or ferrite activator) to move towards the inductive planar coil 11. The gap d between the position element 9 and the planar coil 11 is thereby reduced. When a copper position element 9 i.e. activator is used, this movement of the diaphragm 5 and position element 9 towards the planar coil 11 will induce stronger eddy currents on the position element 9, thereby forcing the inductance H value of the planar coil 11 to be reduced with respect to its nominal value.

If a ferrite material is used for the position element 9, a different effect will occur. Because the ferrite material is electrically nonconductive, i.e. an insulator, no eddy current is produced in the ferrite. Rather, due to the relative permeability, which can be greater than one hundred, the position element 9 behaves as the magnetic field concentrator, or magnetic conductor for the field produced by the planar coil 11. This in turn increases the inductance H value of the planar coil 11 with respect to its nominal value.

FIG. 7 shows a schematic diagram of a system comprising a pipeline 23 for carrying a fluid that is a liquid and an embodiment of the device. The liquid flows past a barrier provided within the pipeline 23. On a first side of the barrier, the pressure of the fluid has a first value. The pressure of the liquid within the pipeline 23 is diverted to the side of the diaphragm 5 external to the cavity 7 of an inventive measuring device, such as the one shown in FIG. 6. On a second side of the barrier, which is generally on the downstream side with respect to the liquid flow within the pipeline 23, the pressure of the liquid has a second value that differs from the first value depending on the speed of the flow. The pressure at this point is diverted to the cavity 7 of the inventive device 1 for measuring pressure, and the inside of the cavity 7 is therefore exposed. Since the pressure difference varies depending on the flow properties, such as velocity, of the liquid in the pipeline 23, the flow can be measured by determining the difference in pressure.

In a flow measurement application such as the one depicted in FIG. 7, the planar coil 11 can be coated with an insulating, i.e. non-conducting, coating such as paint or Teflon i.e. PTFE. This has a negligible effect on the inductance H of the coil 11, but provides a valuable protection for the coil 11 during exposure to the materials flowing in the pipeline 23. An inductance H based pressure measurement device 1 therefore provides a very reliable & robust measurement technique as by dielectric changes, dust and moisture have little influence on the inductance H. The solution is also a very cost effective solution to the flow measurement problem.

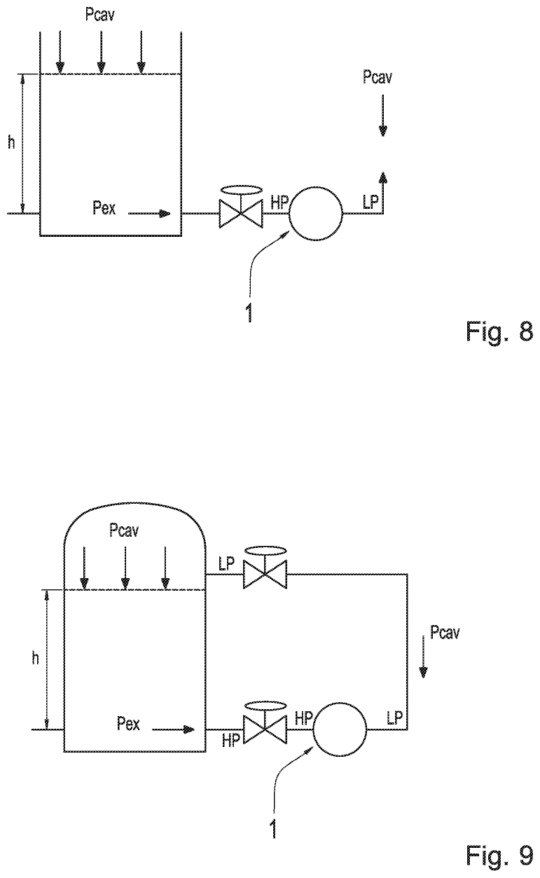

FIG. 8 shows a schematic diagram of a further application of an embodiment of the inventive device 1 for measuring pressure, wherein the device 1 is used to measure the fill level of a tank 25. Here, the tank 25 is filled to a level h with a liquid. The tank 25 i.e. container is exposed to atmospheric pressure. The pressure at the bottom of the tank 25 is therefore directly coupled to the fill level of the tank 25. The device 1 is exposed to the pressure at the bottom of the tank 25, and the cavity 7 of the device 1 is exposed to atmospheric pressure. This gauge pressure device 1 can therefore measure the differential pressure due to the liquid filling the container.

FIG. 9 shows a schematic diagram of a further fill level measurement application of an embodiment of the inventive device. A tank 25 i.e. container is shown as in FIG. 8. However, the tank 25 is closed and pressurized to a certain pressure. The pressure at any point in the tank 25 is a summation of the pressure of the liquid filling the tank 25 above said point, and the ambient pressure provided by the gas near the top of the closed tank 25. To measure the differential pressure, the pressure of the gaseous area of the tank 25 is diverted to the cavity 7 of the inventive device. The pressure at a certain point, which can be near the bottom of the tank 25, is diverted to the external surface of the diaphragm 5 of the device 1. Therefore, the pressure build up in the tank 25 is neutralized, and the pressure due to the liquid in the tank 25 is proportional to the deformation of the diaphragm 5.

The systems of device 1 for measuring pressure and container as depicted in FIGS. 8 and 9 can be provided with at least one valve to permit a simplified installation of the device 1.

### REFERENCE CHARACTERS

1 Device
3 base body
5 diaphragm
7 cavity
9 a position element
11 inductive planar coil
13 processing unit
15 housing
17 signal generating unit
19 receiving interface
21 communications interface
23 pipeline
25 tank/container
PCB printed circuit board
Pcav pressure cavity
Pex external pressure
Vd spatial dimension
d magnitude of the spatial dimension
H inductance ΔH changing inductance
h liquid level in tank
L1 first line
L2 second line
L3 third line

1. A device for measuring pressure comprising:
a base body;
a diaphragm arranged on the base body such that the base body and the diaphragm at least partially enclose a cavity, and such that the diaphragm is configured to be exposed to an external pressure to be monitored, wherein the diaphragm is deformable in accordance with the external pressure incident on it, such that a distance in a spatial dimension of the cavity is correspondingly changed;
a position element fixedly attached to the diaphragm and configured to move in accordance with the diaphragm; and
an inductive planar coil arranged at least one of on or in the base body, across the cavity and opposite to the position element, such that the position element and the inductive planar coil are separated by the distance in the spatial dimension, wherein the position element influences an inductance of the coil dependent on the distance in the spatial dimension;
wherein the device is configured to determine the external pressure based on the inductance of the inductive planar coil.

2. The device according to claim 1, further comprising a processing unit, wherein the processing unit comprises a signal generating unit electrically connected to the coil and configured to generated an electrical input signal that can be transmitted to the coil.

3. The device according to claim 2, wherein the processing unit comprises an evaluation unit comprising a signal receiving interface electrically connected to the coil and the signal generating unit, wherein the evaluation unit is configured to determine the external pressure based on an electrical output signal output from the coil to the signal receiving interface.

4. The device according to claim 3, wherein the processing unit comprises a sampling module configured to sample the output signal from the coil.

5. The device according to claim 1, wherein the position element comprises copper.

6. The device according to claim 1, wherein the position element comprises an electrically isolating and ferromagnetic material.

7. The device according to claim 1, wherein the diaphragm is formed from a ceramic material.

8. The device according to claim 1, wherein the diaphragm is formed from a metal.

9. The device according to claim 1, wherein the position element is substantially flat and has at least one of a rhombus or a hexagonal shape.

10. The device according to claim 1, wherein the coil comprises a printed conducting pathway on a substrate.

11. The device according to claim 1, wherein the coil comprises a first layer and a second layer, wherein the first and second layers are substantially aligned.

12. The device according to claim 1, wherein the coil comprises a single layer.

13. A method for measuring pressure with a device, the method comprising:
exposing a diaphragm of the device to an external pressure to be monitored; and
measuring the external pressure on a basis of a change in inductance of an inductive planar coil of the device;
wherein the device comprises:
a base body;
the diaphragm arranged on the base body such that the base body and the diaphragm at least partially enclose a cavity, and wherein the diaphragm is configured to be deformable in accordance with the external pressure incident on it, such that a distance in a spatial dimension of the cavity is correspondingly deformed;
a position element fixedly attached to the diaphragm and configured to move in accordance with the diaphragm; and
the inductive planar coil arranged at least one of on or in the base body, across the cavity and opposite to the position element, such that the position element and the inductive planar coil are separated by the distance in the spatial dimension, wherein the position element influences the inductance of the coil dependent on the distance in the spatial dimension.

14. A differential pressure flow meter for measuring a flow of a liquid through a pipe comprising the device for measuring pressure according to claim 1.

15. A differential pressure level meter for measuring a level of a liquid in a container comprising the device for measuring pressure according to claim 1.

16. The device according to claim 4, wherein the sampling module comprises an analog to digital converter.

17. The device according to claim 6, wherein the electrically isolating and ferromagnetic material comprises at least one of Nickel-Zinc-Ferrite or Manganese-Zinc-Ferrite.

18. The device according to claim 10, wherein the coil comprises a printed conducting pathway on a printed circuit board.
